(19) United States
(12) Patent Application Publication
(10) Pub. No.: US 2006/0029463 A1
(43) Pub. Date: Feb. 9, 2006

(54) Muntin clip assembly

(76) Inventors: Steven E. Schultz, Rockford, IL (US); Dean Pettit, St. John, IN (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/186,387

(22) Filed: Jul. 21, 2005

Related U.S. Application Data
(60) Provisional application No. 60/589,711, filed on Jul. 21, 2004.

(51) Int. Cl. F16B 7/08

(52) U.S. Cl. 403/187; 52/204.5

(57) ABSTRACT

A muntin clip assembly (40) is provided for connecting a muntin bar (36) having a muntin bar end (38) to a spacer frame (30). The assembly includes a bar support (42) having a tree (46) adapted to be connected to the muntin bar end (38) and a flexible leg (48). The assembly also includes a base member (44) having a slot (56) for receiving the leg (48) and a flexible wing (58) adapted to be connected to the shoulders (35) of the spacer frame (30).

### CROSS-REFERENCE TO RELATED APPLICATIONS

This application claims the benefit of U.S. Provisional Application Ser. No. 60/589,711, filed Jul. 21, 2004, which is incorporated by reference herein and made a part hereof.

### TECHNICAL FIELD

This invention relates generally to muntin grids for sash window assemblies and more specifically to a muntin clip assembly suitable for attaching any muntin bar of a range of sizes to a window assembly.

### BACKGROUND OF THE INVENTION

Double hung window assemblies typically include a pair of sash windows slidably mounted within a master frame. In the past, sash windows were provided with a grid of muntin bars, typically made of wood, that separated and held multiple panes of glass within a sash. Each pane would be mounted within the sash in the same plane. Now, double or multiple pane windows are provided, otherwise known as insulated or thermo-pane window assemblies. These insulated window assemblies include a pair of glass panes mounted in parallel to one another within a sash frame and separated by a small distance. The panes are typically separated by a spacer frame located about a periphery of the panes. Of course, insulated or thermo pane windows are not limited to single or double hung window arrangements. Rather, they have a wide range of applications that are well known in the art. For instance, double pane windows may be incorporated in doors, picture windows, etc.

Grids formed by interconnected muntin bars are often installed between these glass panes of a double pane or insulated sash window. Typically these grids are comprised of multiple muntin bars arranged in a grid pattern and interconnected at interior intersecting points by muntin joiners. The grid is then placed between the panes of glass. The periphery of the grid is then mounted to the sash frame, or more typically, to the spacer frame, by a series of muntin clips. It is understood that the grid can take a variety of different forms.

Typically, the muntin bars are of a tubular or hollow construction and a portion of the clip is received by an end of a muntin bar located at a periphery of the grid. Typically, the hollow muntin bar receives an extension of the clip that is designed to fit tightly within the hollow muntin bar to effect an interference fit, thereby attaching the muntin clip to the muntin bar end. (See FIG. 8) The clip in turn is attached or connected in some way to the spacer frame. An example of a prior art muntin clip is shown in cross section in FIG. 8. The prior art muntin clip 1 includes a bar support 2, in the form of a tree, tightly fitting within and received by a muntin bar 3. Connecting structure 4 of the clip 1 then connects the clip 1 and bar 3 to the window assembly.

Muntin grids, including the bars, joiners and clips of which they are comprised, come in numerous shapes and sizes. One drawback resulting from this fact is that muntin clip manufactures must design and produce a separate clip to match each potential size/shape of muntin bar available on the market. A conservative estimate is that there are currently at least 500 muntin clip designs available on the market to accommodate the multitude of sizes and shapes that can be found in the available muntin bars. This costs clip manufacturers, and window manufacturers or assemblers to incur costs associated with maintaining and otherwise dealing with large and varied inventories of muntin clips.

FIGS. 9 and 10 show a spacer frame. The spacer frame typically has a lateral wall having a length C, a pair of vertical walls having a height B, and a pair of shoulders, each having a length X. The shoulders are separated by a distance A. As one might expect, various window designs may and do require variously sized spacer frames. Typically, a manufacturer will adjust the length of the lateral wall C to accommodate window designs having differing widths between their multiple panes of glass. However, for each different value of C (length of lateral or bottom wall), the height B of the vertical wall and the length of the shoulder X remain as constants. Therefore, as the length C of the lateral wall varies between the various required spacer frame designs, the distance A between the shoulders also varies. This distance plays a role in determining what muntin clip may be used with a particular spacer frame.

Accordingly it can be seen that there are at least two factors dictating what type or design of muntin clip may be used in a particular window assembly. First is the configuration of the muntin bar to be used. The second factor is the configuration of the spacer frame. The multitude of variations available in both muntin bars and spacer frames results in the present existence of at least 500 different muntin clip designs currently being available. This in turn causes clip manufacturers and window assemblers to be burdened with large clip inventories.

The present invention is provided to solve these and other problems.

### SUMMARY OF THE INVENTION

The invention includes a muntin clip assembly for connecting a muntin bar having a muntin bar end to a spacer frame. The assembly includes a bar support having a tree adapted to be connected to the muntin bar end and a flexible leg. The assembly also includes a base member having a slot for receiving the leg and a flexible wing adapted to be connected to the shoulders of the spacer frame.

Other features and advantages of the invention will be apparent from the following specification taken in conjunction with the following drawings.

### BRIEF DESCRIPTION OF THE DRAWINGS

FIG. 1 is an exploded view of a clip assembly according to the present invention;

FIG. 1a is an exploded view of an alternative embodiment of a clip assembly according to the present invention;

FIG. 2 is a perspective view of the clip assembly of FIG. 1 in a partially assembled state;

FIG. 2a is a perspective view of the clip assembly of FIG. 1a in a partially assembled state;

FIG. 3 is a perspective view of the clip assembly of FIG. 1 in an assembled state;

FIG. 3a is a perspective view of the clip assembly of FIG. 1a in an assembled state;

FIG. 4 is a perspective view of the clip assembly of FIG. 1 in an assembled state showing an underside thereof;

FIG. 4a is a perspective view of the clip assembly of FIG. 1a in an assembled state showing an underside thereof;

FIG. 5 is an additional perspective view of the clip assembly of FIG. 1;

FIG. 5a is an additional perspective view of the clip assembly of FIG. 1a;

FIG. 6 is a perspective view of a window sash having a muntin grid;

FIG. 7 is a partial cross section view taken along the line 7-7 of FIG. 6;

FIG. 8 is a schematic representation of a prior art muntin clip;

FIG. 9 is a partial perspective view of a spacer frame member;

FIG. 10 is a cross sectional view taken along the line 10-10 of FIG. 9;

FIG. 11 is a perspective view of an alternative embodiment of a base member of a clip assembly according to the present invention;

FIG. 12 is a perspective view an additional alternative embodiment of a base member of a clip assembly according to the present invention;

FIG. 13 is a perspective view of yet an additional alternative embodiment of a base member of a clip assembly according to the present invention; and

FIG. 14 is a schematic view showing a base member according to the present invention being inserted into a spacer frame.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

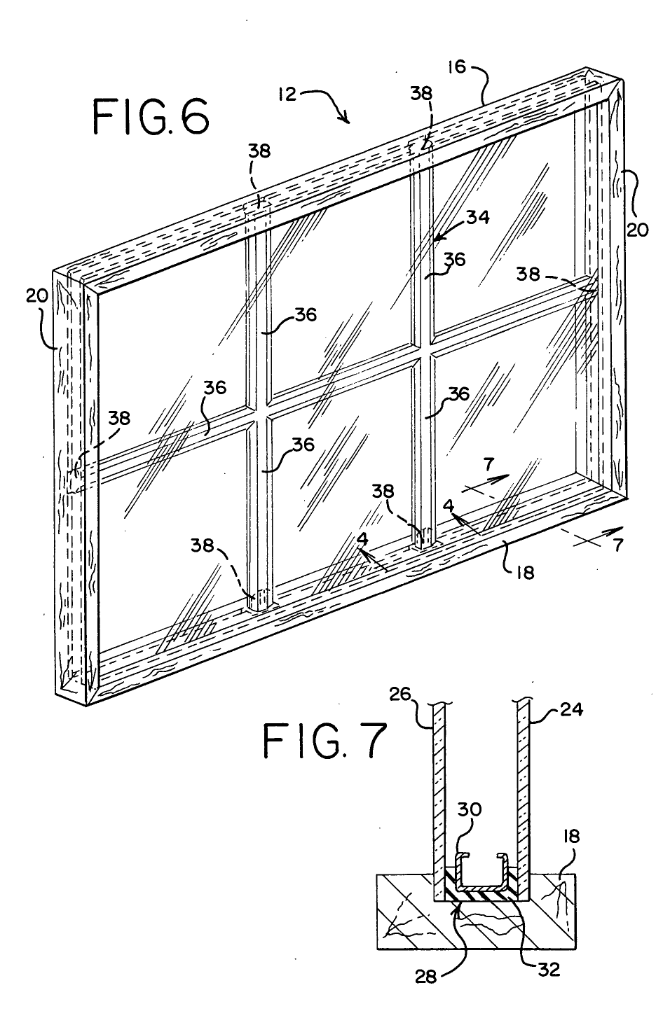

FIG. 6 shows a sash window 12 comprised of a top sash rail 16, a base sash rail 18 and a pair of vertical stiles 20. Although not shown, the sash window 12 may be mounted, slidingly or otherwise, within a master frame, such as, in a single or double hung window arrangement as is well known in the art.

As shown in FIG. 7, each sash window 12 also includes a first pane of glass 24 and a second pane of glass 26 mounted in parallel relationship to one another within an interior of the sash window 12. The first and second panes 24, 26 are spaced by a spacer assembly 28 located at a periphery of the panes 24, 26. The spacer assembly 28 comprises a spacer frame 30 and a seal or sealant 32. The spacer frame 30 is generally tubular with a rectangular or square cross section as seen in FIG. 7, 9 & 10. The spacer frame 30 extends about the entire periphery of the first and second panes 24, 26. A seal or sealant 32 is applied to an outer region of the spacer frame 30. When pressed between the first and second panes 24, 26, the spacer assembly 28 forms an air tight seal between the two panes 24, 26. Each spacer frame 30 includes a bottom wall 31, a pair of side walls 33 and a pair of shoulders 35. Each shoulder 35 also includes a pair of notches 37 such that four notches 37 are located in proximity to one another as shown in FIG. 10.

A muntin grid 34 is positioned between the first and second panes of glass 24, 26. The muntin grid 34 is comprised of a plurality of interconnecting muntin bars 36. Each muntin bar 36 has a generally tubular and hollow construction. Various means of inter-connecting the muntin bars 36 are known to those of ordinary skill in the art. The connecting means are not further described herein and any means of connecting the muntin bars 36 to one another may be utilized. As can be seen from the figures, the muntin bars 36 are so interconnected to form a grid 34 which is positioned between the first and second panes of glass 24, 26. Extending towards and located at a periphery of the grid 34 are a plurality of muntin bar ends 38. It is understood that the grid 34 can take a variety of forms.

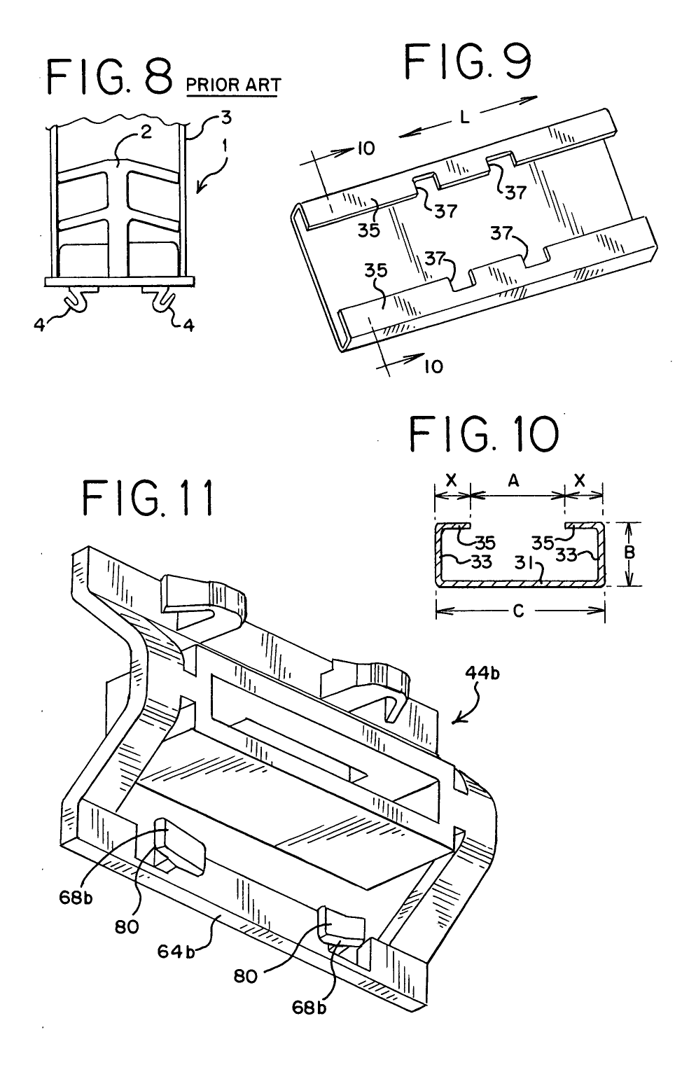

According to the prior art, a muntin clip 1 (See FIG. 8.) is inserted into each muntin bar end 38 to in turn connect each muntin bar end 38 and the entire grid 34 to the spacer frame assembly 28. According to the present invention, a muntin clip assembly 40 is used to connect each muntin bar end 38 to the spacer frame assembly 28, to be explained.

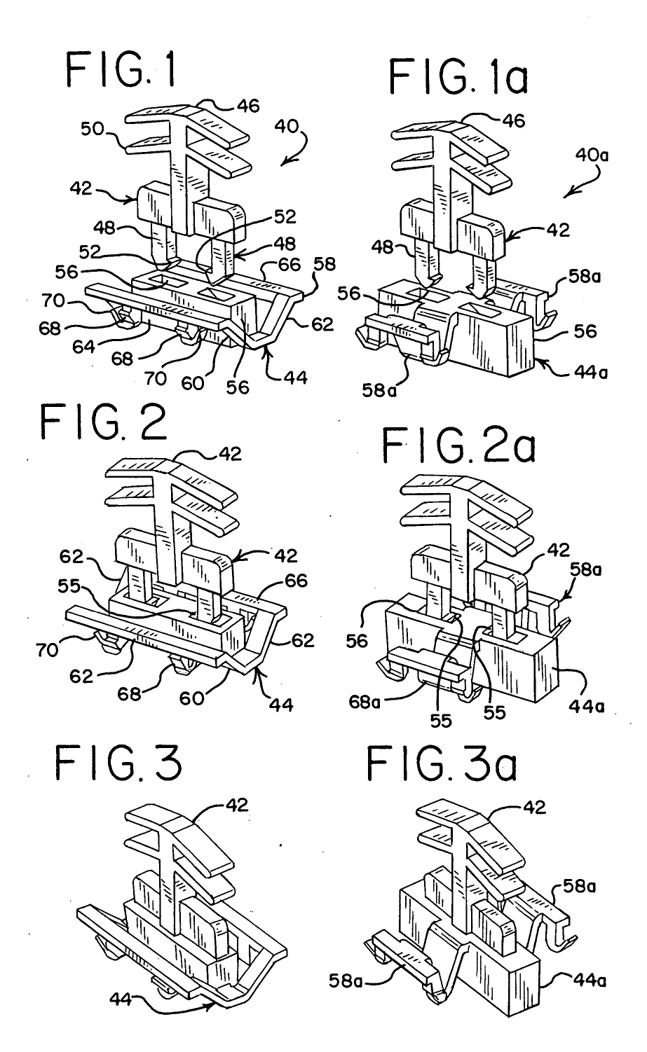

FIG. 1 depicts one embodiment of a clip assembly 40 according to the present invention. The clip assembly 40 includes a bar support member 42 and a base member 44. The bar support member 42 includes a support member 46 extending in a first direction and a pair of resilient flexible legs 48 extending in a second direction. The support member 46 preferably takes the form of a tree adapted to be inserted in a muntin bar end. Most preferably, the tree 46 includes a plurality of fingers 50 extending outwardly from the tree 46 and is adapted to fit relatively tightly within the muntin bar end 38. Each leg 48 preferably includes a lip 52 adapted to engage the base member 44, to be explained.

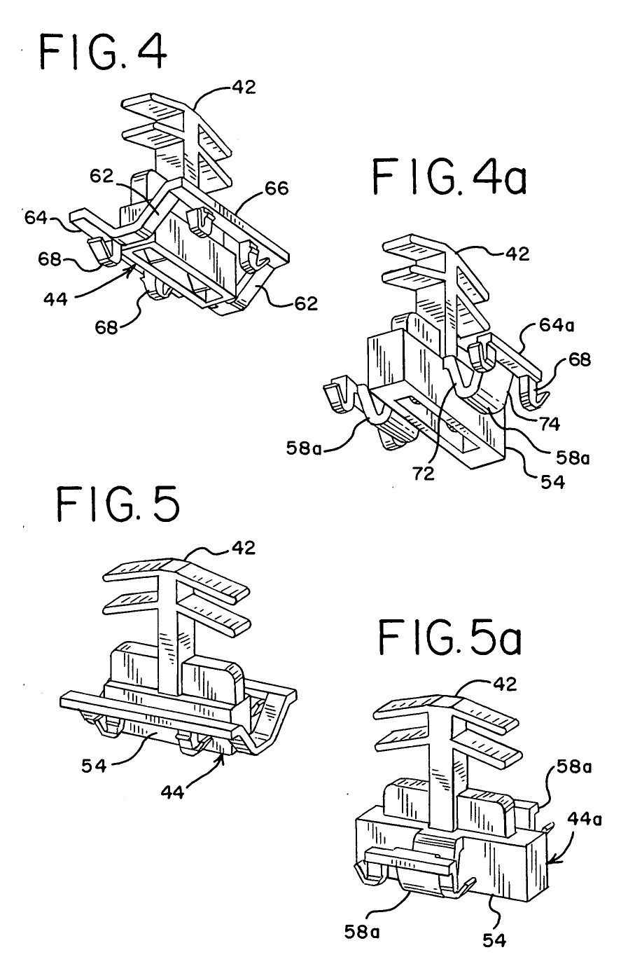

The base member 44 is adapted to engage a portion of the bar support to retain the bar support, and includes a connection member 58 adapted for connection to the spacer frame 30. Preferably, the base member 44 includes a retaining block 54 that engages and retains the bar support, and the connection member 58 is attached to the retaining block 54. Preferably, the connection member 58 is a flexible wing 58, and most preferably, a V-shaped flexible wing, as illustrated in FIGS. 1-5a and 11-14. The retaining block 54 is generally rectangular, as shown, however, it is understood that the retaining block 54 may take any suitable shape so long as it is adapted to be engaged by, and retain, the bar support member 42. The retaining block 54 preferably includes a pair of slots 56, each defining a retaining edge or surface 55 as can be appreciated from FIG. 4. Alternately, the retaining edge or surface 55 can be defined by grooves or indentations in the retaining block 54, or may be located on the outer edges of the retaining block. As illustrated in the FIGS., the retaining block 54 is located within and near a bottom of the V-shaped wing assembly 58.

The V-shaped wing assembly 58 includes a first pair of resilient and flexible inclined walls 60 extending away from the retaining block 54. The V-shaped wing 58 also includes a second pair of resilient and flexible inclined walls 62 extending away from the retaining block 54. The first pair of inclined walls 60 are connected by a first cross member 64 and the second pair of inclined walls 62 are connected by a second cross member 66. Depending from each cross member 64, 66 is a pair of latch members 68, each also including a resilient flexible finger 70. Each flexible finger 70 extends from its respective latch member 68 in a direction parallel with a length of its respective cross member 64, 66. As described herein, the V-shaped wing assembly 58 need not be perfectly V-shaped. Any substantially V-shaped structure, including a U-shaped or other similar structure is contemplated to be fall within the scope of the term “V-shaped.”

In other embodiments, the connection member 58 may take another form, such as flexible tabs extending from the outer surface of the base member 44 or indentations in the base member, preferably with a cooperating structure on the spacer frame 30 to facilitate connection. Alternately, the connection member 58 may be a flexible wing having a different shape designed for connection to the spacer frame 30. For example, the flexible wing 58 may be S-shaped, W-shaped, or may have a slight curve or even no curvature. Other embodiments of a V-shaped wing assembly 58 are described below.

The clip assembly 40 includes a connecting structure or connection means for connecting the bar support 42 to the base member 44. Preferably, this connection means includes the flexible legs 48 on the bar support 42 that fit within the slots 56 of the base member, described above. To assemble the bar support member 42 to base member 44 the legs 48 of the bar support member 42 are each inserted into a respective slot 56 in the retaining block 54, as shown in FIG. 2. Once fully inserted, the legs 48 each flex to allow their lips 52 to engage a respective retaining edge 55 of each slot 56. (See, FIGS. 3, 4 and 5.) This engagement connects the bar support member 42 to the base member 44. It is understood that various other connection means can be used to connect the bar support 42 to the base member 44. Generally, any other known and suitable means for connecting the bar support 42 to the base member 44 may be utilized. For example, the base member 44 may include male-like connecting structure or leg and the bar support member 42 may include corresponding female-like connecting structure. As described above, the base member 44 may include retaining edges 55 that are not formed by slots, and can be formed on the edges of the base member 44. Any of a variety of interference-fitting or friction-type connections or staple-like connections may be used as well. The connecting structure can be any cooperative structure between the base member 44 and the bar support 42 that operates to connect the structures. It is understood that the connecting structure is in the form of the legs 48 and slots 56 is one preferred embodiment of the connecting structure of the present invention.

To connect the preferred clip assembly 40 to a spacer frame assembly 28 the bottom portion of the V-shaped wing 58 is inserted into the spacer frame 30 such that a length of each cross member 64, 66 is generally parallel with a length L of the spacer frame as shown in FIG. 9. Each of the latch members 68 is positioned to generally line up with a respective notch 37 located in the shoulders 35 of the spacer frame 30. When the latch members 68 are inserted into their respective notches 37, each flexible finger 70 deflects to allow the insertion, then returns to its original position to receive a portion of the shoulder 35 between the finger 70 and a respective cross member 64, 66. This latching connects the base member 44 to the spacer frame 30.

The base member 44 accommodates any of a plurality of spacer frames so long as the frames have a distance A between shoulders (See, FIG. 10.) within a given range for the particular base member 44. FIG. 14 shows a spacer frame 30 having a width A between shoulders 35. In phantom is shown a more narrow width A′. Because of the flexibility of the inclined walls 60, 62 of the V-shaped wing 58, any given base member 44 will accommodate a ranged of widths between shoulders between A and A′. In other words, the flexibility will allow each cross member 64, 66 to move closer towards the retaining member 54 to thereby accommodate a more narrow width A.

FIGS. 1a, 2a, 3a, 4a and 5a show a clip assembly 40 having an alternative embodiment of a base member 44a. Rather than a single V-shaped wing 58, this alternative embodiment includes a pair of V-shaped wings 58a, with the retaining block 54 located there between. This is perhaps best seen in FIG. 4a. Each V-shaped wing 58a includes a first flexible inclined wall 72 attached at one end to the retaining block 54 and attached at another end to a second flexible inclined wall 74. Also attached to the second inclined wall 74 is a cross member 64a similar to the previously described cross members 64, 66. Depending from the cross member 64a is a pair of latch members 68, similar to those previously described. The retaining block 54 of this embodiment may be identical to that described above including its configuration of slots 56.

In this alternative embodiment, it can be seen that first and second flexible incline walls 72, 74 combine to allow the base member 44ato accommodate a range of widths between spacer frame shoulders in a manner similar to that described above. This alternative embodiment would typically accommodate a range of widths A that are wider than that for a similar base member constructed with the single V-shaped wing 58 as previously described.

It should be noted that multiple bar support members (approximately 40) must be designed to accommodate a range of muntin bar shapes and sizes. However, each of these multiple bar support members will be capable of being inserted in and connecting with either of the described base members 42, 42a. In turn, each base member 40, 40a is capable of connecting to a range of spacer frame configurations. These features of the described two piece muntin clip assembly 40, 40a combine to greatly reduce the overall number and size of muntin clip inventories that manufacturers and assemblers have previously been required to maintain.

Other forms of the support member 46 are contemplated in addition to the friction fit method described above, including those that do not fit within the muntin bar end 38. Additionally, the tree 46 may take a different form, including a solid post that forms an interference fit with the muntin bar end 38. Additionally, a separate or integral connector, staple or other fastener may be used.

FIG. 11 shows the underside of an additional embodiment of a base member 44b. In this embodiment, the latch members 68b comprise a flexible tab 80 extending from the cross member 64b. In all other respects, this base member 44b is similar to the previously described base member 44. This tab 80 design increases the ease with which the base member 44b may be injection molded as it will not require camming with the tab 80 design. It is understood that the base member 44b of FIG. 11 is inserted into and connects to a spacer frame 30 in a similar fashion as the base members previously described.

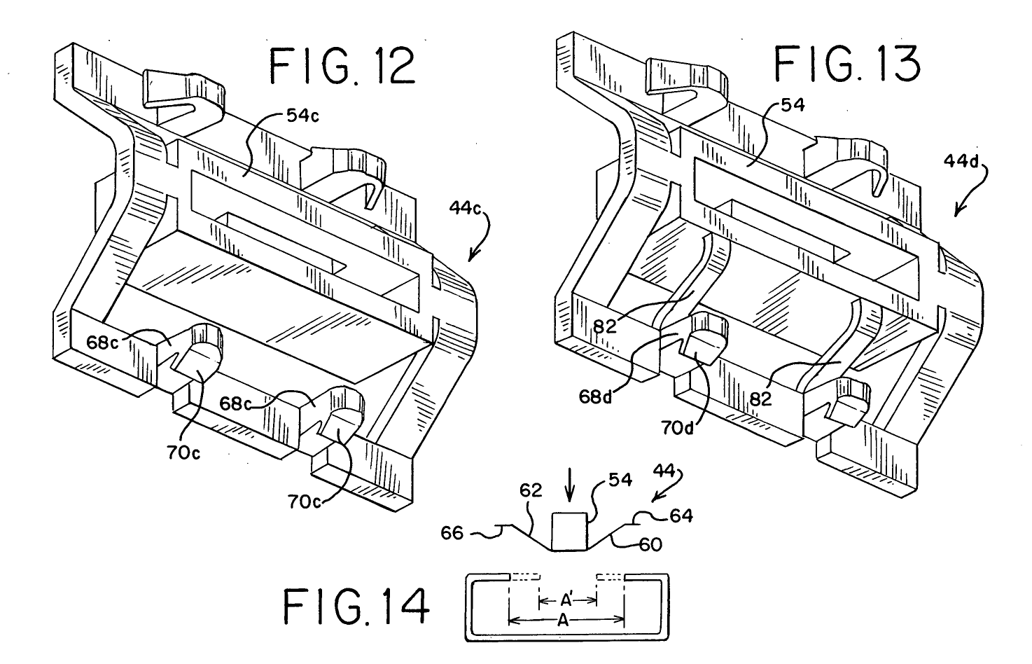

FIG. 12 shows the under side of an additional embodiment of a base member 44c. In this embodiment, the latch members 68c include flexible fingers 70c that extend from their respective latch members 68c in a direction also away from the retaining member 54c. In other words, the latch members 68c are rotated 90 degrees as compared to the orientation of the latch member 68 of previous embodiments. In all other respects, the base member 44c is identical to the base member 44 previously described.

FIG. 13 shows the under side of yet an additional embodiment of a base member 44d. In this embodiment, the latch members 68d also include fingers 70d that extend in a direction away from the retaining member 54. This embodiment also includes a plurality of ribs 82 spaced about a length of the cross member 64d connected at one end to the cross member 64d and at another end to the retaining member 54. These ribs 82 add strength and rigidity to the overall structure of the base member 44d.

It is noted that each of the embodiments of FIGS. 11, 12, and 13 also depict a pair of latch members 68 as described in connection with the embodiment of FIG. 1. This is done primarily for comparison's sake. However, it is noted that any combination of latch members is acceptable. Also, any means of latching or connecting between the cross bars and the spacer frame assembly is acceptable, including friction fitting and/or a separate fastener.

While the specific embodiments and various details thereof have been illustrated and described, numerous modifications come to mind without significantly departing from the spirit of the invention and the scope of protection is only limited by the following claims.

What is claimed is:

1. A muntin clip assembly adapted to be connected to a muntin bar end and a spacer frame, the assembly comprising:
a bar support having a support member adapted to be connected to the muntin bar end; and
a base member connected to the bar support to retain the bar support, the base member having a connection member adapted for connection to the spacer frame.

2. The muntin clip assembly of claim 1, wherein the bar support further comprises a flexible leg and the base member engages the flexible leg to retain the bar support.

3. The muntin clip assembly of claim 2, wherein the base member further comprises a slot receiving the flexible leg.

4. The muntin clip assembly of claim 1, wherein the base member further comprises a retaining block engaging a portion of the bar support to retain the bar support and the connection member comprises a flexible wing adapted to engage the spacer frame to connect the base member to the spacer frame.

5. The muntin clip assembly of claim 4, wherein the flexible wing is adapted to flex toward the retaining block to permit connection to any of a variety of different spacer frames.

6. The muntin clip assembly of claim 4, wherein the flexible wing comprises a latch member adapted to be inserted in a notch in the spacer frame and to engage the spacer frame.

7. The muntin clip assembly of claim 1, wherein the base member further comprises a retaining block engaging a portion of the bar support to retain the bar support and the connection member comprises a V-shaped flexible wing adapted to engage the spacer frame to connect the base member to the spacer frame.

8. The muntin clip assembly of claim 7, wherein the connection member further comprises a second V-shaped flexible wing adapted to engage the spacer frame to connect the base member to the spacer frame.

9. The muntin clip assembly of claim 1, wherein the support member comprises a tree adapted to be inserted in the muntin bar end, the tree having a plurality of fingers thereon.

10. A muntin clip assembly adapted to be connected to a muntin bar end and a spacer frame, the assembly comprising:
a bar support comprising a support member and a flexible leg, the support member adapted for connection to the muntin bar end; and
a base member comprising a retaining block and a flexible wing, the retaining block having a slot that receives the flexible leg to retain the bar support and the flexible wing adapted to engage the spacer frame to connect the base member to the spacer frame.

11. The muntin clip assembly of claim 10, wherein the support member comprises a tree adapted to be inserted in the muntin bar end.

12. The muntin clip assembly of claim 10, wherein the slot defines a retaining edge, and the flexible leg has a lip, wherein the lip engages the retaining edge.

13. The muntin clip assembly of claim 10, wherein the bar support further comprises a second flexible leg, and the retaining block is has a second slot that receives the second flexible leg.

14. The muntin clip assembly of claim 10, wherein the flexible wing is V-shaped.

15. The muntin clip assembly of claim 14, wherein the V-shaped flexible wing comprises a first pair of resilient inclined walls extending away from the retaining block and connected by a first cross member and a second pair of resilient inclined walls extending away from the retaining block and connected by a second cross member.

16. The muntin clip assembly of claim 14, wherein the base member further comprises a second V-shaped flexible wing adapted to engage the spacer frame to connect the base member to the spacer frame.

17. A member for a muntin clip assembly, adapted to be connected to a muntin bar support member and a spacer frame, the base member comprising:
a retaining block adapted to engage and retain the muntin bar support member;
a flexible wing extending from the block and adapted to engage the spacer frame to connect the base member to the spacer frame.

18. The base member of claim 17, further comprising a second flexible wing extending from the block and adapted to engage the spacer frame to connect the base member to the spacer frame.

19. The base member of claim 18, wherein both of the flexible wings are V-shaped.

20. The base member of claim 17, wherein the flexible wing is V-shaped and comprises a first pair of resilient inclined walls extending away from the retaining block and connected by a first cross member and a second pair of resilient inclined walls extending away from the retaining block and connected by a second cross member.

21. The base member of claim 20, wherein the V-shaped flexible wing comprises a first pair of latch members depending from the first cross member and a second pair of latch members depending from the second cross member, each of the latch members adapted to engage the spacer frame.

22. The base member of claim 17, wherein the flexible wing comprises a latch member adapted to engage the spacer frame.

23. A muntin bar support for a muntin clip assembly, adapted to be connected to a muntin bar and a base member connected to a spacer frame, the muntin bar support comprising:
a tree member adapted to be inserted in the muntin bar end; and
a flexible leg extending from the tree member and adapted to engage the base member to retain the muntin bar support on the base member.

24. The muntin bar support of claim 23, wherein the tree member comprises a plurality of fingers extending outwardly from the tree member.

25. The muntin bar support of claim 23, further comprising a second flexible leg extending from the tree member and adapted to engage the base member to retain the muntin bar support on the base member

26. The muntin bar support of claim 23, wherein the flexible leg comprises a lip adapted to engage a retaining edge of the base member.

27. A muntin clip assembly adapted to be connected to a muntin bar end and a spacer frame, the assembly comprising:
a bar support comprising a support member adapted to be connected to the muntin bar end;
a base member adapted to be connected to the spacer frame; and
means for connecting the bar support to the base member.

28. A muntin clip assembly adapted to be connected to a muntin bar end and a spacer frame of a window assembly, the muntin clip assembly comprising:
a bar support having a support member and a pair of flexible legs, each leg having a lip, the support member adapted to be connected to the muntin bar end; and
a base member having a pair of slots, each slot defining a retaining edge, the base member further having a flexible wing adapted to engage the spacer frame to connect the base member to the spacer frame, wherein each slot receives a flexible leg, wherein a respective lip engages a respective retaining edge to connect the bar support to the base member.
